(19) United States
(12) Patent Application Publication
(10) Pub. No.: US 2004/0202908 A1
(43) Pub. Date: Oct. 14, 2004

(54) Line system for fluids and gases in a fuel cell

(75) Inventors: Guido Schmitz, Dulmen (DE); Harald Hager, Recklinghausen (DE); Hans Ries, Marl (DE); Olivier Farges, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/820,862

(22) Filed: Apr. 9, 2004

(30) Foreign Application Priority Data
Apr. 11, 2003 (DE) 103 16 996.2

(51) Int. Cl. H01M 8/10

(52) U.S. Cl. 429/30; 429/33

(57) ABSTRACT

A component of a line system of a fuel cell, comprises:

a) an innermost layer I, which is in contact with the conveyed fluid and is comprised of a polyester molding composition, and,

b) at least one other layer present which is selected from the group consisting of:

i) a layer II comprised of a polyamide molding composition,

ii) a layer III comprised of a molding composition comprised of a functionalized polyolefin,

iii) a layer IV comprised of a polyolefin molding composition in which the polyolefin is not functionalized, and

iv) a layer V comprised of an EVOH molding composition.

### BACKGROUND OF THE INVENTION

1. Field of the Invention

The present invention relates to an element for a line system which is part of a fuel cell and which comes into contact with fluids and gases.

2. Description of the Background

The ever more rigorous legislation relating to the environment is forcing the manufacturers of motor vehicles to consider new propulsion systems, because one of the specific issues on which legislators are increasingly focused is NOₓ emissions. The fuel cell is one possible alternative propulsion system.

A wide variety of embodiments of fuel cells have long been known in the prior art. A common feature of the fuel cells is that a fuel is fed to the anode compartment and air or oxygen is fed to the cathode compartment. At the electrodes, these reactants undergo catalytic reaction. The fuels used for such cells comprise such materials as hydrogen, methanol, glycol, methane, butane, higher hydrocarbons, and the like. But only when the first of these is used are current densities achieved that are sufficiently high to permit a fuel cell operating at approximately room temperature to be used for the propulsion of a motor vehicle. The other fuels are capable of undergoing satisfactory reaction only in a medium- or high-temperature fuel cell, which limits interest in these fuel cells primarily to stationary installations. For this reason, the fuel in an electrically-propelled motor vehicle that draws its current from a fuel cell assembly intended to be operated using methanol or hydrocarbons is usually converted in a reformer, using water vapor at relatively high temperature, to give hydrogen and carbon dioxide, the reaction gas being freed from the carbon monoxide by-product, and the hydrogen/CO₂ mixture being conducted into the anode compartment. The equipment currently favored for this purpose is the “proton exchange membrane fuel cell”, in which there is a water-saturated acidic ion-exchanger membrane between the porous, catalyst-containing electrodes. However, the direct oxidation of methanol is also the subject of current work for mobile applications, and the implementation of this method would render a reformer superfluous.

The lines for fuel feed have hitherto usually been produced from high-specification steel. However, these lines are expensive.

JP 2002-213659 A discloses lines for hydrogen transport that are composed of a polyolefin inner layer, an EVOH intermediate layer, and a polyamide outer layer. This publication discloses the recognition of the problem of the general lack of adhesion between these layers, by mentioning the use of an adhesive between layers which is not described in any further detail. A need therefore has existed for an element which is part of the line system of a fuel cell which has improved barrier action with respect to hydrocarbons, alcohols, and hydrogen, and which, furthermore, exhibits secure adhesion between layers.

### SUMMARY OF THE INVENTION

Accordingly, one object of the present invention is to provide a line system of a fuel cell system which with absolute certainty entirely eliminates or permits to the very smallest extent the leaching of components from the line system which can react with the electrolyte or with the anode material that would poison the catalyst of the fuel cell or which would cause undesired polarization of the cell.

Briefly, this object and other objects of the present invention as hereinafter will become more readily apparent can be attained by a line system which is part of a fuel cell, which comprises:

an innermost layer I, which contacts the fluid that is conveyed within the line system, which is composed of a polyester molding composition and,

at least one other layer, which is selected from the group consisting of

i) a layer II comprising a polyamide molding composition,

ii) a layer III comprising a molding composition comprising a functionalized polyolefin,

iii) a layer IV comprising a polyolefin molding composition in which the polyolefin has not been functionalized, and also

iv) a layer V comprising an EVOH molding composition.

### DETAILED DESCRIPTION OF THE PREFERRED EMBODIMENTS

U.S. Patent Application No. 2003-072987, which is not a prior art publication, describes an object which is part of a line system of a fuel cell and in which the portion of the line system that is in contact with the conveyed fluid is comprised of a polyester molding composition.

Examples of the objects of the invention are a pipe or a pipe-like molding, which may be a multilayer pipe, in which the innermost layer is comprised of a polyester molding composition. This pipe or pipe-like molding may be produced either as a smooth pipe which is then, where appropriate, thermoformed, or as a corrugated pipe. Mention should also be made of objects in which fluids are stored, for example feed vessels. Examples of other objects are links, for example what are known as quick connectors, adaptors, filters, components in pumps, or components in valves.

The objects of the invention may be produced by the usual methods of plastics processing, for example, by means of coextrusion, e.g. multilayer pipe, blow molding, or specialized forms thereof, such as suction blow molding or 3D parison manipulation, the parison being coextruded, injection molding, and associated specialized processes, e.g. the fluid injection technique, or rotational sintering.

By way of example, the layer structure of the element of the invention may be, from the outside to the inside:

II/I

II/adhesion promoter/I

III/II//adhesion promoter/I

IV/III/II/adhesion promoter/I

IV/adhesion promoter/I

II/V/II/adhesion promoter/I

II/III/V/III/II/adhesion promoter/I

III/I

IV/III/I

IV/III/V/III/I

II/V/adhesion promoter/I

The thermoplastic polyesters that are employed to form the innermost layer I are prepared by polycondensing diols with dicarboxylic acids or with their polyester-forming derivatives, such as dimethyl esters. Suitable diols have the formula HO—R—OH, where R is a divalent, branched or unbranched aliphatic and/or cycloaliphatic radical having from 2 to 40, preferably from 2 to 12, carbon atoms. Suitable dicarboxylic acids have the formula HOOC—R′—COOH, where R′ is a divalent aromatic radical having from 6 to 20, preferably 6 to 12, carbon atoms.

Suitable examples of diols include ethylene glycol, trimethylene glycol, tetramethylene glycol, bute-2-ene-1,4-diol, hexamethylene glycol, neopentyl glycol, cyclohexanedimethanol and the C₃₆ diol known as dimer diol. The diols may be used alone or as a diol mixture.

Suitable examples of aromatic dicarboxylic acids include terephthalic acid, isophthalic acid, naphthalene-1,4-, -1,5-, -2,6-, or -2,7-dicarboxylic acid, diphenic acid and diphenyl ether 4,4′-dicarboxylic acid. Up to 30 mol % of these dicarboxylic acids, and preferably up to 10 mol %, may be replaced by aliphatic or cycloaliphatic dicarboxylic acids having from 3 to 50 carbon atoms, preferably having from 6 to 40 carbon atoms, e.g. succinic acid, adipic acid, sebacic acid, dodecanedioic acid or cyclohexane-1,4-dicarboxylic acid.

Suitable examples of polyesters include polyethylene terephthalate, polypropylene terephthalate, polybutylene terephthalate, polyethylene 2,6-naphthalate, polypropylene 2,6-naphthalate, polybutylene 2,6-naphthalate, poly(1,4-dimethylenecyclohexane terephthalate) and poly(1,4-dimethylenecyclohexane 2,6-naphthalate).

The preparation of these polyesters is prior art (U.S. Pat. No. 4,329,444; U.S. Pat. No. 4,066,627; Ullmanns Encyclopädie der technischen Chemie [Ullmann's Encyclopedia of Industrial Chemistry], 4th edn., Vol. 19, pp. 65 seq. Verlag Chemie, Weinheim, 1980).

Particularly suitable polyesters have been found to be those which comprise not more than 300 ppm, preferably not more than 150 ppm, particularly preferably not more than 100 ppm, and very particularly preferably not more than 50 ppm, based in each case on the metal content, of any metal compound that catalyzes transesterification and/or esterification, or conversion products thereof, irrespective of whether the reason for this is clear.

The polyester molding composition may comprise up to about 40% by weight of other thermoplastics, in particular impact-modifying rubbers. It may moreover comprise the additives and auxiliaries usually used for polyesters, e.g. processing aids, nucleating agents, intercalated or exfoliated phyllosilicates, crystallization accelerators, light stabilizers, heat stabilizers, metal scavengers or complexing agents, conductivity-increasing additives, such as carbon black, carbon fibers, steel fibers, nanotubes, etc., reinforcing additives, such as glass fibers, or pigments.

These additives have to be selected in such a way that they result in no, or only a very slight, increase in the conductivity of the fluid which passes over the polyester molding composition. If the fluid used comprises water, the conductivity at 90° C. should rise only by a maximum of 100 μS/cm, preferably a maximum of 50 μS/cm, and particularly preferably a maximum of 30 μS/cm. If a mixture of water and methanol (60:40% by volume) is used, the conductivity at 90° C. should rise only by a maximum of 80 μS/cm, preferably a maximum of 40 μS/cm and particularly preferably a maximum of 20 μS/cm.

The polyester molding composition generally has a continuous polyester phase, and it is preferable here for the entire matrix to be composed of polyester and for the other components to be dispersed therein.

In one particular embodiment, the polyester molding composition is rendered anti-electrostatic by means of the abovementioned conductivity-increasing additives, so that electrostatic charges can be reliably dissipated during the transport of combustible fluids. In this case, there is an insulating element separating the line system and the anode, as is the case of the high-specification steel lines used hitherto.

Suitable polyamides are known to those of skill in the art, and many grades of these are commercially available. By way of example, it is possible to use PA46, PA66, PA68, PA610, PA612, PA88, PA810, PA1010, PA1012, PA1212, PA6, PA7, PA8, PA9, PA10, PA11, PA12, and copolyamides based thereon, branched polyamine-polyamide copolymers, and mixtures thereof. With regard to suitable homo- and copolyamides and suitable polyamine-polyamide copolymers, reference may be made to U.S. Pat. No. 2,002,142118 and US-A-2002082352, the disclosure of which is expressly incorporated herein by way of reference.

The polyamide molding compositions used may comprise a maximum of about 50% by weight of additives selected from impact-modifying rubber and/or from conventional auxiliaries and/or from conventional additives.

Impact-modifying rubbers for polyamide molding compositions are known in the art. They contain functional groups which are derived from unsaturated functional compounds, these having been either copolymerized in the main chain or grafted onto the main chain. The most commonly encountered materials are EPM or EPDM rubber which is free-radical-grafted with maleic anhydride groups. These rubbers may also be used together with a non-functionalized polyolefin, e.g. isotactic polypropylene, as described in U.S. Pat. No. 5,874,176.

The molding compositions may also further comprise relatively small amounts of the auxiliaries or additives needed to establish certain properties. Examples of such additives are plasticizers, pigments or fillers, such as carbon black, titanium dioxide, zinc sulfide, silicates or carbonates, processing aids, such as waxes, zinc stearate, or calcium stearate, flame retardants, such as magnesium hydroxide, aluminum hydroxide, or melamine cyanurate, glass fibers, antioxidants, UV stabilizers, and additives which give the product anti-electrostatic properties or electrical conductivity, e.g. carbon fibers, graphite fibrils, stainless steel fibers, or conductivity black.

In one possible embodiment, the molding compositions comprise from 1 to 25% by weight of plasticizer, particularly preferably from 2 to 20% by weight, and particularly preferably from 3 to 15% by weight.

Plasticizers and their use with polyamides are known. A general overview of plasticizers suitable for polyamides may be found in Gächter/Müller, Kunststoffadditive [Plastics Additives], C. Hanser Verlag, 2nd Edition, p.296. By way of example, compounds usually used and suitable as plasticizers are esters of p-hydroxybenzoic acid having from 2 to 20 carbon atoms in the alcohol component, or amides of arylsulfonic acids having from 2 to 12 carbon atoms in the amine component, preferably amides of benzenesulfonic acid.

Suitable plasticizers which may be used include ethyl p-hydroxybenzoate, octyl p-hydroxybenzoate, isohexadecyl p-hydroxybenzoate, N-n-octyltoluenesulfonamide, N-n-butylbenzenesulfonamide, or N-2-ethylhexylbenzenesulfonamide.

As to polyolefin layers III and IV, suitable polyolefins include polyethylene and polypropylene. In principle, use may be made of any commercially available grade. For example, high-, medium-, or low-density linear polyethylene, LDPE, isotactic or atactic homopolypropylene, random copolymers of propene with ethene and/or 1-butene, ethylenepropylene block copolymers, and other similar materials are acceptable. The polyolefin may also comprise a toughener, e.g. EPM or EPDM rubber, or SEBS. The usual auxiliaries and additives may also be present. The polyolefin may be prepared by any known process, for example by the Ziegler-Natta or the Phillips process, by a metallocene or free-radical route.

The molding composition of the layer IV may be crosslinked as in the prior art, in order to improve mechanical properties, e.g. low-temperature impact strength, heat resistance, or creep, or permeability. Examples of crosslinking methods are radiation crosslinking or, in the case of polyolefin molding compositions containing silane groups, moisture crosslinking.

The polyolefin of the layer III may contain functional groups such as anhydride groups, N-acyllactam groups, carboxylic acid groups, epoxy groups, oxazoline groups, trialkoxysilane groups, or hydroxy groups. These functional groups may be introduced either via copolymerization of a suitable monomer together with the olefin or via a graft reaction. In the case of the graft reaction, a previously formed polyolefin is reacted in a known manner with an unsaturated functional monomer and advantageously with a free-radical generator at an elevated temperature.

EVOH, as the material for layer V, has been known for a long time. It is a copolymer of ethylene and vinyl alcohol, and is sometimes also termed EVAL. The ethylene content in the copolymer generally ranges from 25 to 60 mol %, and in particular from 28 to 45 mol %. A wide variety of grades of the copolymer are commercially available. By way of example, reference may be made to the company publication “Introduction to Kuraray EVAL™ Resins”, Version 1.2/9810 from Kuraray EVAL Europe.

EVOH is generally prepared by hydrolyzing ethylene-vinyl acetate copolymers. According to the invention, for reasons of better processability, the EVOH used may also comprise a partially hydrolyzed ethylene-vinyl acetate copolymer in which the extent of hydrolysis carried out is at least 60%, preferably at least 80%, and particularly preferably at least 90%. Better processability may also be achieved via admixture of polyvinyl acetate, or of ethylene-polyvinyl acetate copolymers, or of polyamides. The EVOH molding composition may moreover comprise any of the other known additives from the prior art, including, for example, phyllosilicates. The proportion of EVOH in the molding composition should be at least 50% by weight, preferably at least 60% by weight, particularly preferably at least 75% by weight, and very particularly preferably at least 90% by weight.

By way of example, suitable adhesion promoters for bonding the layer I to a layer II are known from U.S. Pat. No. 5,258,213, U.S. Pat. No. 5,932,686, and U.S. Pat. No. 6,355,358, the disclosure of which is expressly incorporated herein by way of reference.

By way of example, suitable adhesion promoters for bonding layer I to layer IV are blends composed of polyester and polyolefin and, respectively, functionalized polyolefin, where appropriate with addition of a compatibilizer, such as a polyamine-polyamide copolymer (U.S. Pat. No. 6,355,358).

By way of example, suitable adhesion promoters for bonding layer I to layer V are known as disclosed in U.S. Pat. No. 4,528,219, the disclosure of which is expressly incorporated herein by way of reference. Other suitable materials are blends composed of the polyester used in layer I and of an EVOH-compatible polyamide (e.g. PA6, PA66, or copolymers thereof), where appropriate with addition of a compatibilizer, e.g. of a polyamide-polyester block copolymer, and polyamine-polyamide copolymers may also be used as an alternative adhesion promoter as in U.S. Pat. No. 6,355,358, where appropriate with addition of an EVOH-compatible polyamide and/or of the polyester used in layer I.

All of these adhesion promoters are present as a separate layer which is formed, by way of example, via coextrusion with the other layers.

The inventive line system or its individual elements can be produced at low cost. Furthermore, it has low weight, and this is specifically advantageous for mobile use.

The invention also provides a fuel cell system which comprises an inventive element, for example for the propulsion of a motor vehicle.

The disclosure of German Patent application No. 103 16 996.5 filed Apr. 11, 2003, is hereby incorporated by reference into the present application.

Obviously, numerous modifications and variations of the present invention are possible in light of the above teachings. It is therefore to be understood that within the scope of the appended claims, the invention may be practiced otherwise than as specifically described herein.

What is claimed as new and is intended to be secured by Letters Patent is:

1. A component of a line system of a fuel cell, comprising:
a) an innermost layer I, which is in contact with the conveyed fluid and is comprised of a polyester molding composition, and,
b) at least one other layer present which is selected from the group consisting of:
i) a layer II comprised of a polyamide molding composition,
ii) a layer III comprised of a molding composition comprised of a functionalized polyolefin,
iii) a layer IV comprised of a polyolefin molding composition in which the polyolefin is not functionalized, and
iv) a layer V comprised of an EVOH molding composition.

2. The component of a line system of a fuel cell as claimed in claim 1,
wherein the component is a multilayer pipe, a feed vessel, a link, an adaptor, a filter, a component of a pump, or a component of a valve.

3. The component of a line system of a fuel cell as claimed in claim 1, wherein the polyester molding composition is based on a polyester which is selected from the group consisting of polyethylene terephthalate, polypropylene terephthalate, polybutylene terephthalate, polyethylene 2,6-naphthalate, polypropylene 2,6-naphthalate, polybutylene 2,6-naphthalate, poly(1,4-dimethylenecyclohexane terephthalate) and poly(1,4-dimethylenecyclohexane 2,6-naphthalate).

4. The component of a line system of a fuel cell as claimed in claim 3, wherein the polyester molding composition is is such that when a fluid comprising water is passed over the layer, the conductivity at 90° C. rises only by a maximum of 100 μS/cm.

5. The component of a line system of a fuel cell as claimed in claim 4, wherein the conductivity at 90° C. rises only by a maximum of 50 μS/cm.

6. The component of a line system of a fuel cell as claimed in claim 1, wherein the polyester molding composition of layer I is such that when a fluid comprising water and methanol is passed over the layer, the conductivity at 90° C. rises only by a maximum of 80 μS/cm.

7. The component of a line system of a fuel cell as claimed in claim 6, wherein the conductivity at 90° C. rises only by a maximum of 40 μS/cm.

8. The component of a line system of a fuel cell as claimed in claim 1, wherein the polyester molding composition comprises up to about 40% by weight of at least one other thermoplastic.

9. The component of a line system of a fuel cell as claimed in claim 1, wherein the polyester molding composition comprises one or more additives selected from the group consisting of processing aids, nucleating agents, intercalated or exfoliated phyllosilicates, crystallization accelerators, light stabilizers, heat stabilizers, metal scavengers or complexing agents, conductivity-increasing additives, nanotubes, reinforcing additives and pigments.

10. The component of a line system of a fuel cell as claimed in claim 1, wherein the polyamide of layer II is selected from the group consisting of PA46, PA66, PA68, PA610, PA612, PA88, PA810, PA1010, PA1012, PA1212, PA6, PA7, PA8, PA9, PA10, PA1, PA12, copolyamides thereof, branched polyamine-polyamide copolymers, and mixtures thereof.

11. The component of a line system of a fuel cell as claimed in claim 1, wherein the polyamide composition of layer II contains an impact modifier of EPM or EPDM rubber having maleic anhydride units grafted thereon.

12. The component of a line system of a fuel cell as claimed in claim 1, wherein
the polyamide composition of layer II contains an auxiliary or additive selected from the group consisting of plasticizers, pigments, fillers, processing aids, flame retardants glass fibers, antioxidants, UV stabilizers, and additives which impart anti-electrostatic properties or electrical conductivity to the product.

13. The component of a line system of a fuel cell as claimed in claim 12, wherein the polyamide composition of layer II contains from 1 to 25% by wt of a plasticizer.

14. The component of a line system of a fuel cell as claimed in claim 13, wherein the plasticizer is ethyl p-hydroxybenzoate, octyl p-hydroxybenzoate, isohexadecyl p-hydroxybenzoate, N-n-octyltoluenesulfonamide, N-n-butylbenzenesulfonamide, or N-2-ethylhexylbenzenesulfonamide.

15. The component of a line system of a fuel cell as claimed in claim 1, wherein the polyolefin of layer III or IV is a high-, medium-, or low-density linear polyethylene, LDPE, isotactic or atactic homopolypropylene, random copolymers of propene with ethene and/or 1-butene, ethylene-propylene block copolymer.

16. The component of a line system of a fuel cell as claimed in claim 1, wherein the EVOH copolymer of layer V has an ethylene monomer content of 25 to 60 mole %.

17. The component of a line system of a fuel cell as claimed in claim 1, wherein the EVOH copolymer of layer V is such that at least 60% of the acetate groups of the copolymer are hydrolyzed.

18. The component of a line system of a fuel cell as claimed in claim 1, wherein the polyester molding composition has been rendered antielectrostatic.

19. A fuel cell system which comprises a component as claimed in claim 1.

20. A fuel cell system for the propulsion of a motor vehicle, which comprises an element as claimed in claim 1.
